(19) United States
(12) Patent Application Publication
(10) Pub. No.: US 2009/0107623 A1
(43) Pub. Date: Apr. 30, 2009

(54) Continuous venting of a covering sheet for an in-situ lamination process

(75) Inventors: Dewayne J. Davidson, Pace, FL (US); Michael D. Kridel, Wooster, OH (US); Richard H. Swasey, Pace, FL (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: Davidson et al.

(21) Appl. No.: 11/981,192

(22) Filed: Oct. 31, 2007

(51) Int. Cl. B32B 38/04

(52) U.S. Cl. 156/252

(57) ABSTRACT

A method of venting a rear facer sheet for lamination is accomplished by continuously drawing the rear facer sheet through a perforating device which creates conical apertures in the rear facer. Two metal rails affixed to opposing edges of a front facer are continuously drawn into a laminator after first having an expanding foam material continuously deposited onto the upper surface of the front facer. The perforated rear facer is continuously drawn into the laminator and affixed to the two metal rails, creating an enclosed volume in which the expanding foam is located. The apertures in the rear facer allow for the escape of gasses and air during lamination, promoting even flow and uniform density of the foam material. The perforating device has an upper and a lower rotating cylinder, the lower cylinder being equipped with piercing elements and the upper cylinder being equipped with grooves corresponding to the piercing elements.

### TECHNICAL FIELD

One or more embodiments of the present invention relate to a method of venting a covering used in a lamination process. Specifically, one or more embodiments of the present invention relate to a continuous method of venting a rear facer sheet used in a lamination process forming a garage door panel.

### BACKGROUND ART

Movable barriers, such as garage doors and the like, generally include a multi-panel door supported by a track system, upon which the door is movable between an open, horizontal position and a closed, vertical position. The door panels are pivotally secured to each other via hinges and movably secured to the track system via rollers.

Consumers have steadily indicated a desire for lighter weight, thermally efficient door panels, to reduce energy costs and noise while improving safety. Such door panels may be constructed using a front facer and a rear facer that define a volume therebetween. That volume may be filled with a foamed polymer material or the like. The foam adds structural integrity, adheres the panel components together, and improves the door's insulating properties. Such designs are lighter and in some cases less expensive than traditional solid wood or metal doors.

In some cases these foam filled panels are constructed using both a non-metal front facer and a non-metal rear facer. Such panels typically include internal metal supports, also referred to as rails, to provide added stability. Further, such panels may be made in a continuous production process wherein a front facer having opposed longitudinal edges is continuously provided, a metal rail is continuously secured to each longitudinal edge, a foaming material is continuously applied on the front facer between the rails, a rear facer is continuously brought into contact with the rails, and the front facer, metal rails, rear facer and foaming material are drawn through a laminator which includes a plurality of rollers. This continuous production process is an improvement in many respects over the prior method, known as a batch process, in which one panel was formed in a mould at a time. The continuous production method is more efficient, less time consuming, and may be less expensive.

Though the aforementioned continuous production method has proven successful in making door panels having non-metal front and rear facers, certain limitations have become evident. Most notably, foam gasses and air become trapped beneath the rear facer during lamination, causing non-uniform flow of the foaming material. This non-uniform flow of the foaming material results in varying densities of foam within the laminated door panel, thereby causing uneven drying times. The trapped gasses and air also cause defects in the adhesion of the foam to the front facer, rear facer and metal rails. The uneven flow of the foaming material, and the trapped air and gasses can cause delays in processing and can cause defective and weakened door panels. If the fill is not uniform, due to restrictions, trapped gas, or trapped air during the expansion of the foam, the foam will develop voids, “knit lines,” or weakened areas. Further the trapped air or gas can cause the foam to “skin over” before the foam attaches or adheres to the skin assemblies. It is known in the art to “over pack” the foam filled area to improve the “knit lines” or the adhesion. However this increases the cost and weight of the laminate. Over packing the laminate with foam can have processing downsides. If the foam leaks through the skin assemblies it can accumulate on the processing equipment necessitating a shut down to clean off the accumulated material. It is also known to eliminate the embossments in the skin assemblies to remove the restrictions to the foam distribution during expansion of the foam, but this eliminates the appearance feature of the product. Over packing may also result in exothermic hot spots during processing which may result in deformation of the finished panel, resulting in distortion of embossment patterns on the front facer.

Thus, there exists a need in the art for a method of continuously venting a covering sheet to be used in a lamination process.

### SUMMARY OF THE INVENTION

In light of the foregoing, it is a first aspect of the present invention to provide a method of venting a covering sheet.

It is another aspect of the present invention to provide a method of venting a non-metallic sheet of material in a continuous lamination process of a product comprising continuously providing a sheet, forming apertures in the sheet by continuously drawing the sheet through a perforating device, continuously applying the perforated sheet over a product which has a foaming material disposed thereon, the perforated sheet and the product forming an inner volume, continuously drawing the product and the perforated sheet through a laminator, thereby securing the sheet to the product while the foaming material expands to fill the inner volume.

It is still another aspect of the present invention to provide a method of forming a door panel comprising continuously providing a front facer having two opposing longitudinal edges, the edges each having a rail secured thereto, continuously providing a rear facer wherein the rear facer is continuously drawn through a perforating device creating a perforated rear facer, continuously applying an expanding foam material on the front facer, continuously bringing the perforated rear facer into contact with the rails, thereby creating an enclosed inner cavity, and drawing the front facer, the rails and the rear facer through a laminator including a plurality of rollers, wherein the rollers releasably position the rails and the rear facer as they are drawn through the laminator, and wherein entrapped air and gasses generated by the expanding foam material are released through the perforated rear facer.

### BRIEF DESCRIPTION OF THE DRAWINGS

For a complete understanding of the objects, techniques and structure of the invention, reference should be made to the following detailed description and accompanying drawings, wherein:

FIG. 1 is a side elevation view of a facer production station according to the present invention.

FIG. 2 is an isometric view of a rail forming area;

FIG. 3 is a side plan view of the lamination area of the present invention;

FIG. 4 is a side plan view of a perforation station;

FIG. 5 is a front view of a perforation device according to the present invention;

FIG. 6 is a top perspective view of the perforation device;

FIG. 7 is a cross-section view of the perforation device taken along lines 7-7 of FIG. 6;

FIG. 8 is a front cross-section view of an adjustment mechanism associated with the perforation device according to the present invention;

FIG. 9 is a cross-sectional view of the perforation device taken along lines 9-9 of FIG. 6;

FIG. 10 is an enlarged cross-sectional view of the perforation device with a rear facer received therein;

FIG. 11 is a bottom perspective view of the perforation device;

FIG. 12 is an isometric view of a laminator;

FIG. 13 is a cross-section view of a cured door panel made according to the present invention; and

FIG. 14 is an enlarged cross-section view of the cured door panel.

### BEST MODE FOR CARRYING OUT THE INVENTION

Door panels manufactured by a continuous production method, and the present invention, are typically provided as part of a garage door system, wherein a plurality of adjoining panels are pivotally secured to one another to form a door assembly. The door assembly rides along a track system and is movable between a generally vertical, closed, orientation, and a generally horizontal open, orientation. It should be appreciated, however, that the described method of continuously venting a non-metallic sheet may be employed in the manufacture of any type of laminated panel.

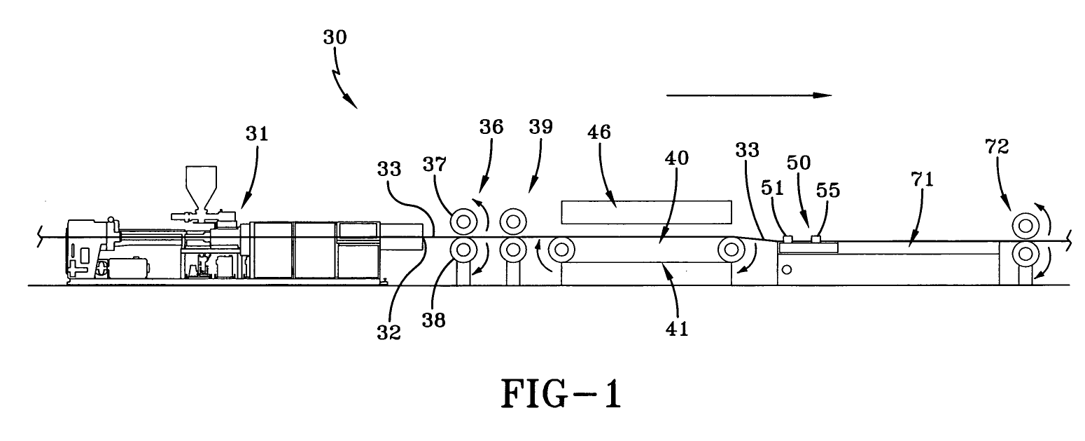

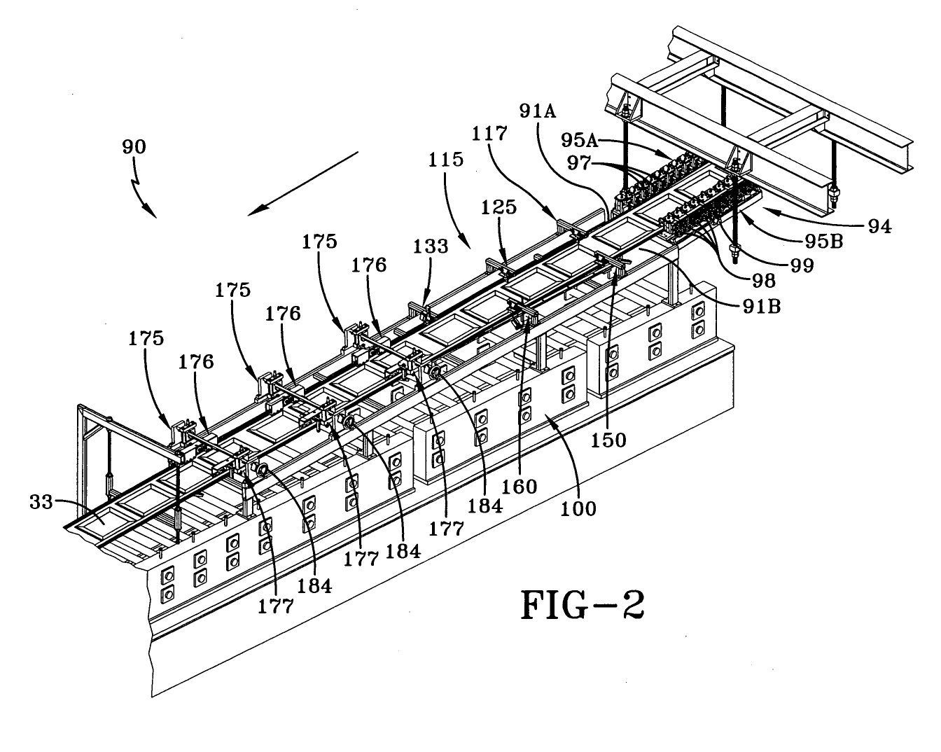

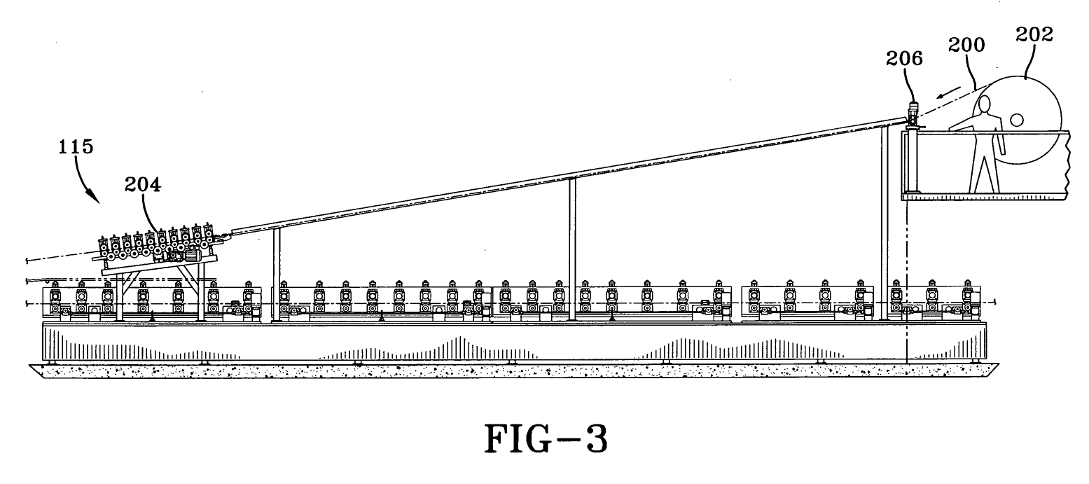

The continuous production method used to produce door panels may be described generally as having three distinct steps or stations. In a facer forming area, shown in FIG. 1, a front facer is formed in a continuous fashion by extruding a sheet of plastic and shaping that sheet into a final form. This front facer is then directed to a rail forming and insertion area, shown in FIG. 2, where metal rails are continually formed and joined with the front facer. Finally, in a laminating area, shown in FIG. 3, a foaming material is discharged onto the front facer and rail assembly. Thereafter, according to the present invention, a perforated rear facer is continuously provided to complete the exterior shell of the panel. The assembly is thereafter directed through a laminator to maintain the position of the components, simultaneously allowing the foam to expand and fill the interior volume while the foam gasses and air are allowed to escape through the rear facer's perforations. After exiting the laminator, the foam is substantially cured and the panel may be cut to length. In one embodiment, if the panels are used in conjunction with a garage door system, the panels may be provided with appropriate hardware, and assembled with other panels to form the garage door.

Referring now to the drawings, an exemplary door panel manufacturing method will now be described. FIG. 1 shows a facer forming area generally designated by the numeral 30. Facer forming area 30 includes an extruder 31 that produces a continuous sheet of pliable plastic material at a substantially constant rate of speed. As is known in the art, extruder 31 is supplied with plastic stock material, typically in the form of pellets, which are heated and pressed through an extruder die 32. In the present embodiment, the plastic stock material is a thermoplastic material such as polyvinylchloride, although any plastic material (including for example, thermoset plastics) may be used so long as it is appropriate for use in an extruder and exhibits sufficient strength and weathering properties. The extruder die 32 of the present embodiment may be described as an elongated straight slot, so that when plastic material is forced therethrough, a continuous flattened front facer 33 in the form of a sheet is produced. Indeed, sheet 33 may also be referred to herein as front facer sheet 33 or front facer 33.

Extruder 31 may include a width control mechanism that is capable of selectively varying the width of front facer sheet 33 to allow for various door panel designs and sizes. As is known in the art, changing the extruder die is somewhat difficult and time consuming, thus, the width control mechanism enables relatively easy width adjustments. In one or more embodiments, width control mechanism may be in the form of a pair of adjustable blades positioned on opposed lateral sides of extruder die 32. The blades may be moved inwardly or outwardly depending on the desired sheet width and the front facer material that contacts the blades is sheared, to be disposed of or recycled. In this manner, front facer sheets of varying widths may be formed using the same extruder die.

After exiting extruder die 32, the thermoplastic material of the front facer sheet 33 has not yet taken a permanent shape, is still impressionable, and may be directed through an embossing roller assembly 36. Embossing roller assembly 36 may include at least one upper roller 37 and an opposed, spaced apart lower roller 38. Rollers 37 and/or 38 may be provided with a textured circumferential surface, and when passed therebetween, that texture may be transposed onto the surface or surfaces of the impressionable sheet 33. Such textures may be for decorative purposes or may be provided to promote adherence to other door panel components. Embossing roller assembly 36 is further provided to propel front facer sheet 33 toward a vacuum former 40 at a predetermined or regulated speed.

Optionally, a temperature compensator 39 may be provided downstream of the embossing roller 36 and prior to vacuum former 40. Temperature compensator 39 may be employed to regulate or adjust the temperature of front facer sheet 33 prior to entry into vacuum former 40. For example, temperature compensator 39 may be in the form of a pair of opposed, spaced apart rollers. If cooling is desired, the rollers may be cooled, for example by a continuous internal stream of chilled fluids. Conversely, if it is desired to maintain a high front facer sheet temperature, the rollers may be heated, by for example, a continuous internal stream of hot fluids. In this manner, the temperature of front facer sheet 33 may be regulated to achieve optimal shaping and forming properties.

Front facer sheet 33 is drawn through vacuum former 40 to form a variety of raised patterns thereon. When assembled in a door system, front facer 33 of the completed door panel is positioned on the exterior side of the door and thus, decorative patterns or embossments may be desirable. Vacuum former 40 may therefore include a patterned loop or belt 41 that is continually drawn along the top surface of a stationary table with both the belt 41 and the stationary table having holes therein. Belt 41 may be made of flexible material such as rubber or plastic and may include a raised repeating pattern on the outer surface thereof. A vacuum is drawn from beneath the stationary table by a suction device and acts on front facer sheet 33 through the holes in belt 41 and the stationary table. The vacuum draws front facer sheet 33 firmly against belt 41, and because front facer sheet 33 is still hot, and thus relatively malleable, the raised pattern of belt 41 is transferred onto front facer sheet 33 forming a patterned surface area. Further, because belt 41 is continuously circulated around the stationary table, front facer sheet 33 is effectively pulled through the vacuum former 40.

Vacuum former 40, as seen in FIG. 1, may further include a cooling system 46 that cools front facer sheet 33 as it travels through vacuum former 40. Cooling system 46 may be positioned above belt 41 and distributes a cooling liquid on front facer sheet 33 as it travels therethrough. The cooling liquid may be water which may be sprayed from a plurality of jets so that the water is dispersed in small droplets to maximize thermal transfer. A trough (not shown) may be provided underneath the belt 41 to collect excess liquid for disposal or re-circulation to the cooling system.

Vacuum former 40 may also be utilized to begin forming the opposing edges, 48A and 48B seen later in FIG. 13, of front facer sheet 33 to facilitate assembly of various other door panel components, as will become apparent. One method of forming the edges of front facer sheet 33 is to angle the edges of the stationary table, across which the front facer sheet is drawn by belt 41, at an upwards angle such that a portion of the front facer sheet 33 that overhangs the belt 41 is forced into an angled edge portion by the stationary table. Also, it should be appreciated that other vacuum former designs and configurations may be employed. Other exemplary vacuum formers are disclosed in U.S. Pat. Nos. 6,641,384 and 5,906,840 which are incorporated herein by reference.

Front facer sheet 33 exits vacuum former 40 with the raised patterned surface area. Further, front facer sheet 33 is cooler than when it entered vacuum former 40. It is, however, not completely set and is therefore still malleable. Thus, in particular, the edge portions of sheet 33 may still be bent or otherwise formed. To complete the formation of edge portions, front facer sheet 33 is next drawn through a post forming area 50 seen in FIG. 1. Post forming area 50 may include conventional formers 51 and 55 which provide a plurality of spaced apertures or slots, through which edge portions 48 are directed through. Such progressive forming systems are well known to persons having ordinary skill in the art. Each aperture may include a shape that is sequentially more similar to the final desired end profile. Further, as will become apparent, the profile of left edge portion 48A may be different than the profile of right edge portion 48B. In this embodiment the edge portions 48 are thus transformed in the post forming area from substantially flat portions angled slightly upwards to the edge portion profiles seen in FIG. 13. It should be noted that although only two formers 51 and 55 are shown in FIG. 1, any number of formers desired may be used.

Facer sheet 33 is next drawn through a water bath 71, shown in FIG. 1, to complete the cooling process and permanently set the shape thereof. Upon exiting water bath 71, facer sheet 33 is no longer impressionable and will thereafter maintain its pattern and end profiles. A puller assembly 72 may be provided to draw facer sheet 33 out of water bath 71. Puller assembly 72 may be in the form of a pair of motorized opposed rollers wherein the opposed rollers counter-rotate to draw front facer sheet 33 through at a predetermined speed.

The completed front facer 33 may now be guided to a rail forming and insertion area 90 (hereinafter rail area 90), shown in FIG. 2. It should be appreciated that prior to entry into rail area 90, a portion of front facer 33 may be allowed to accumulate or hang slack. This accumulation area may be employed to reduce residual tension on front facer 33 and/or allow for minor variations or fluctuations in production speeds between the facer forming area 30 and the rail area 90.

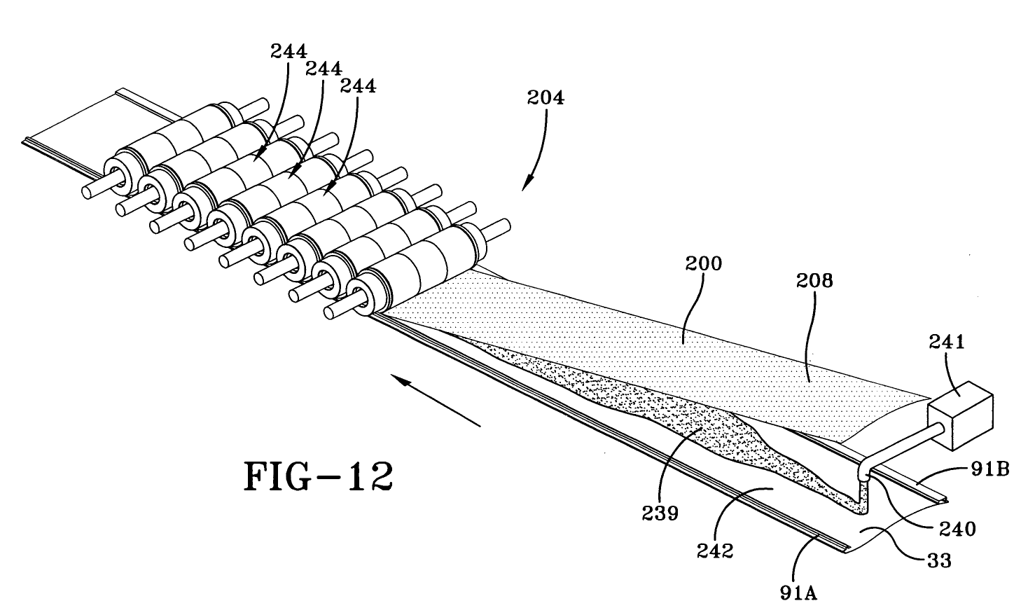

In rail area 90, a pair of rails 91A and 91B are formed and joined with front facer 33. Front facer 33 is first drawn through a rail forming apparatus 94 which is adapted to continuously shape metal strips into a desired cross-sectional profile. Rail forming apparatus 94 includes a left side rail former 95A and a right side rail former 95B. Rail formers 95A and 95B are spaced apart to allow front facer 33 to travel uninhibited therebetween. Each rail former 95 is continuously fed from a separate rail stock roll (not shown). The rail stock is of metal composition and is initially in the form of a flattened strip, wound into a roll. The metal stock is fed through respective rail formers 95 which shape the metal stock as it travels therethrough. Rail formers output shaped rails 91 at a speed substantially matching the speed front facer 33 as it travels through rail area 90. In the present embodiment each rail former 95 may include a plurality of rotating wheels 97 positioned sequentially to shape the passing metal stock. Each rail former may be driven through a gear arrangement 98 driven by a motor 99. In the present embodiment rail forming apparatus 94 shapes rails 91A and 91B to appear as shown later in FIGS. 12 and 13.

After shaping by rail forming apparatus 94, rails 91 are ready to be joined with front facer 33. Rails 91 provide structural stability, as well as a sturdy mounting area for brackets, hinges or other hardware. Downstream of rail forming apparatus 94, rails 91 and front facer 33 are joined by a merging apparatus designated generally by the numeral 115. Merging apparatus 115 generally includes a plurality of guides and rollers that allow rails 91 to be continuously joined with front facer 33. After exiting rail former 95A, left rail 91A is directed through a series of guide blocks 117, 125 and 133, each having a channel corresponding to the shape of left rail 91A. The guide blocks turn and position the left rail 91A to the desired position, and the final guide block 133 includes an adhesive applicator which applies adhesive between the left rail 91A and the edge portion 48A. Similarly, right rail 91B is directed through a series of guide blocks 150 and 160 each having a channel corresponding to the shape of right rail 91B. These guide blocks act to turn and position the right rail 91B to the desired position, and include an adhesive applicator to apply adhesive between the right rail 91B and the edge portion 48B. The number of guide blocks for each rail 91 may vary and are not limited to the numbers shown in the Figures.

As shown in FIG. 3, after traveling through and between the plurality of guide blocks, front facer 33 and rails 91 are thereafter directed through a plurality of pressing assemblies 175. Though the figures show three pressing assemblies, more or less may be used. Pressing assembly 175 completes the merger of rails 91 and front facer 33 by both guiding the components and applying a compressive force thereto. Each pressing assembly 175 includes a left side sub-assembly 176 and a right side sub-assembly 177. Left side sub-assembly 176 effectively guides and presses together left rail 91A and left edge portion 48A as they travel therethrough. Likewise, right-side sub-assembly 177 guides and presses together right rail 91B and right edge portion 48B.

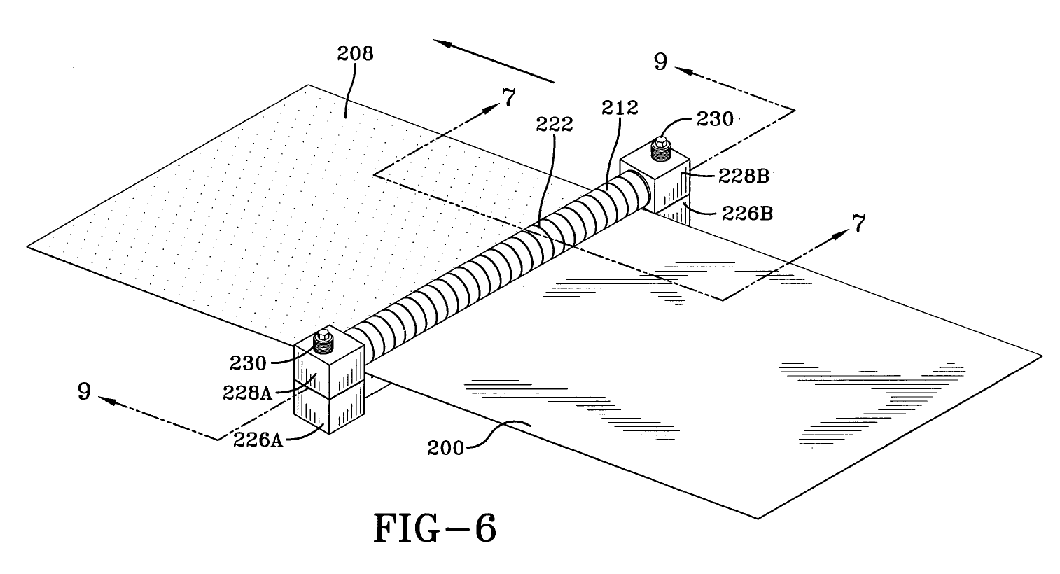

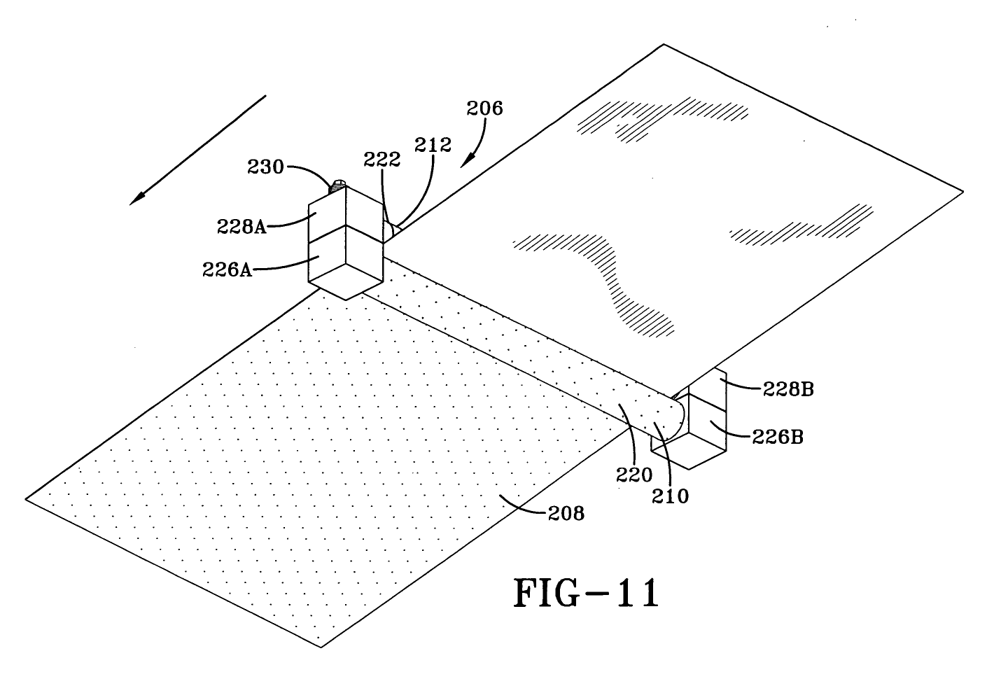

Referring now to FIGS. 3-12 a continuous method of venting a sheet for lamination according to the present invention is presented. The present invention is used in the continuous production process of manufacturing garage door panels. Specifically, the present invention relates to the venting of the rear facer of the door panel. It should be noted, however, that the present invention is not limited to use on a rear facer for lamination of a door panel as described herein. The method of the present invention may be used in conjunction with any continuous lamination of a foam filled article and may be used with either a rear facer or front facer sheet.

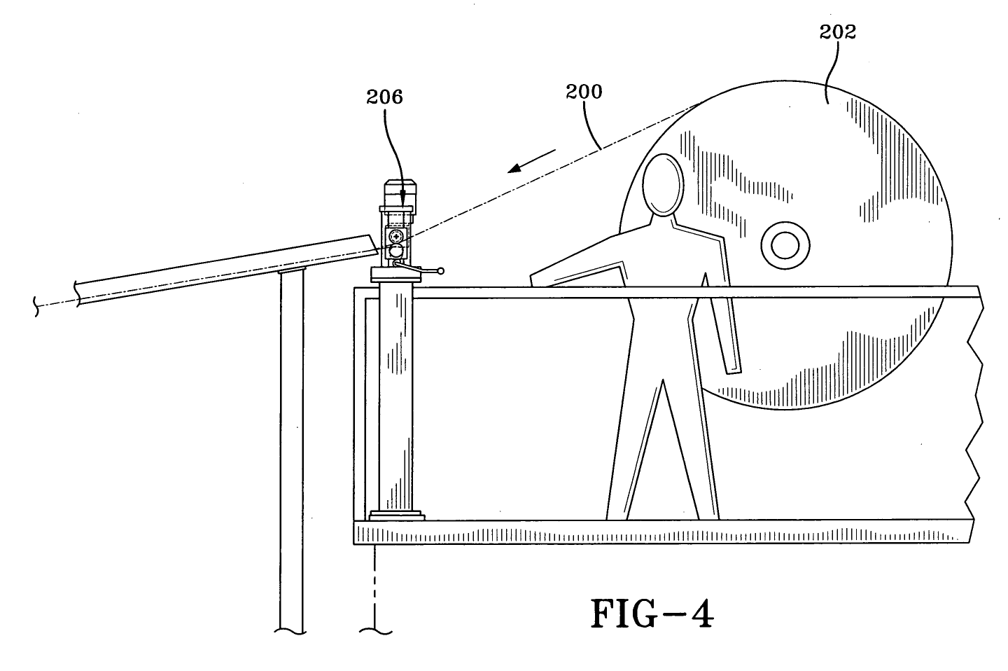

As best seen in FIGS. 3 and 4, a rear facer 200 is continuously provided from a rear facer stock roll 202 which may be positioned above and forward of merging apparatus 115. Rear facer 200 may be of a plastic composition and may for example be polyvinylchloride, although any plastic may be used. In other embodiments rear facer 200 may be craft paper or the like. Rear facer 200, which has an appropriate thickness, is continuously fed from rear facer stock roll 202 into a laminator generally designated by the numeral 204 to be joined with other door panel components as will be hereinafter described.

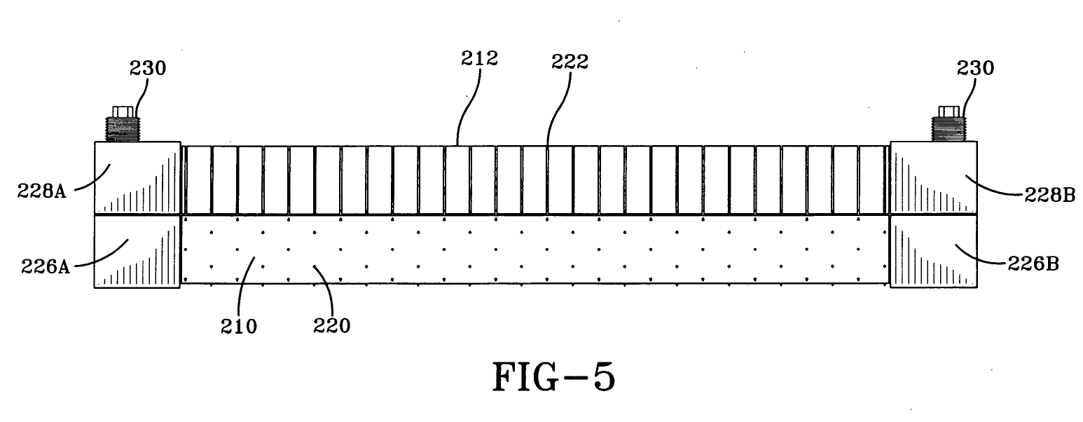

A perforation device 206 is positioned between roll 202 and laminator 204, through which rear facer 200 is continuously fed prior to being fed into laminator 204. Perforation device 206, as shown in FIGS. 5-11, creates or forms apertures 208 in rear facer 200. In one or more embodiments apertures 208 may be uniformly spaced across rear facer 200. Perforation device 206 includes a lower cylinder 210 and an upper cylinder 212. The cylinders are rotatable, and each has a center axis of rotation. The axis of rotation of lower cylinder 210 and the axis of rotation of upper cylinder 212 are substantially parallel in the present embodiment. Lower cylinder 210 includes piercing elements 220 which project from the lower cylinder's outer surface. In the embodiment shown, piercing elements 220 are substantially conical in shape, having a point with which to pierce rear facer 200 and progressively increasing in diameter as piercing element 220 approaches lower cylinder 210. It will be appreciated that the piercing elements could have other shapes depending upon the rear facer's material and thickness. Piercing elements 220 may be arranged about the lower cylinder in uniform radial lines as shown, but may also be arranged in other patterns providing a sufficient number of apertures 208 in rear facer 200. Upper cylinder 212 includes recessed grooves 222 corresponding to the piercing elements 220 positioned on lower cylinder 210. In the present embodiment grooves 222 are in the form of circular recesses in upper cylinder 212, each recess aligned with and corresponding to the line of piercing elements on lower cylinder 210. In the present embodiment, perforation device 206 creates apertures 208 in rear facer 200 that are conical in shape, mirroring the shape of the piercing elements 220.

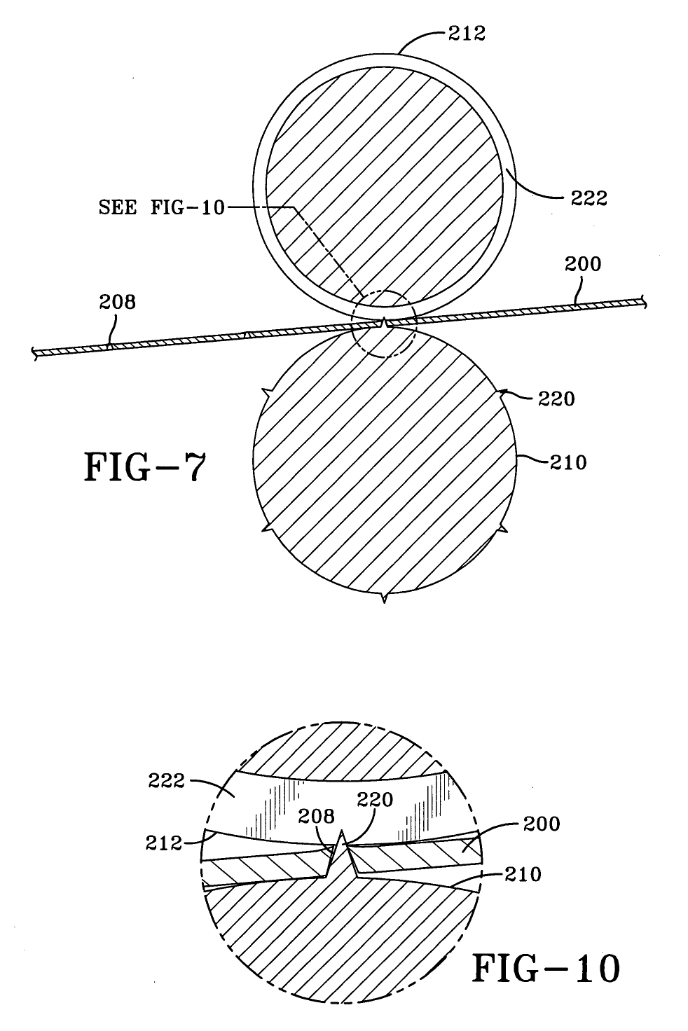

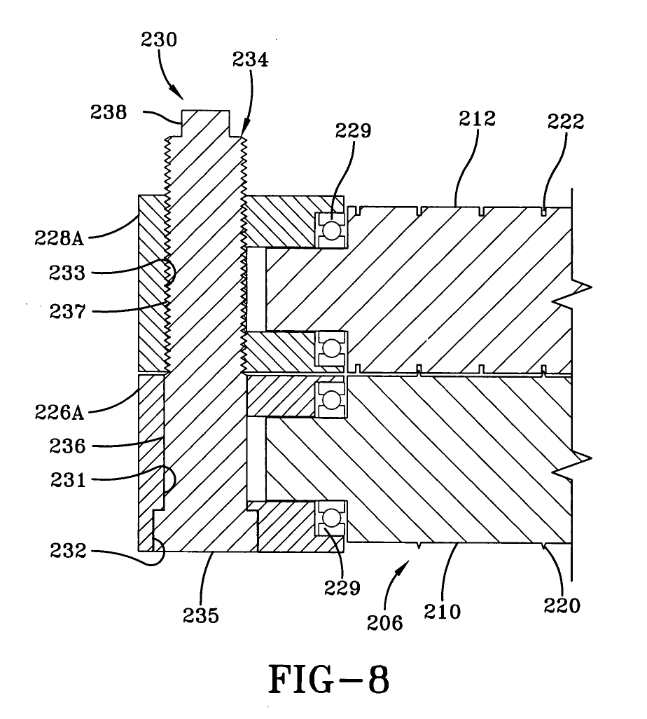

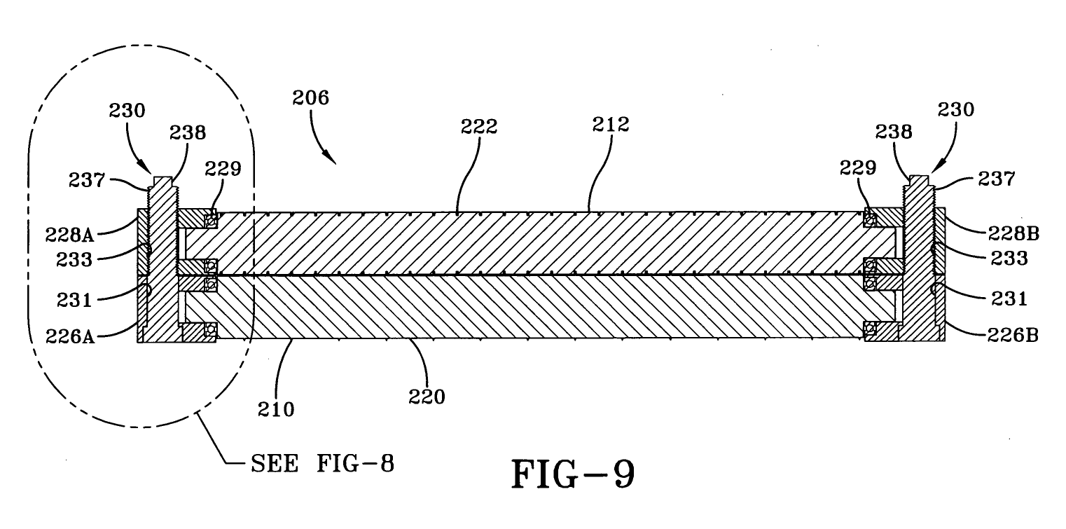

Lower cylinder 210 is rotatably mounted in mounting blocks 226A and 226B, and upper cylinder 212 is rotatably mounted in mounting blocks 228A and 228B. Mounting blocks 226 and 228 include means for allowing lower cylinder 210 and upper cylinder 212 to rotate. As best seen in FIG. 8, ball bearings 229 are mounted within mounting blocks 226 and 228 to allow for rotation of cylinders 210 and 212. The cylinders 210 and 212 are mounted coaxially within the bearings 229. Although the embodiment shown utilizes ball bearings 229, any conventional means for allowing rotation of such cylinders may be employed. Mounting blocks 228 and 226 also include an adjustment mechanism 230 at each end thereof which is adapted to allow for adjustment of the clearance or spacing between lower cylinder 210 and upper cylinder 212. Adjusting the clearance between the cylinders 210 and 212 may result in varying sizes of apertures 208 due to the conical shape of piercing elements 220. Adjustment mechanism 230 allows for rear facers 200 having varying thicknesses to be fed through perforation device 206.

With particular reference now to FIGS. 8 and 9, it can be seen that an adjustment mechanism is designated generally by the numeral 230. The mechanism 230 is associated with blocks 226A/B and 228 A/B. Blocks 226 A/B have a smooth bore 231 extending therethrough along with an aligned and concentric countersink 232. Blocks 228A/B have a threaded bore 233 extending therethrough that is aligned with the smooth bore 231 of corresponding blocks 226 A/B.

A screw 234 has a head 235 from which extends a shaft 236 having a threaded portion 237. A hex head 238 or other non-circular configuration axially extends from the threaded portion 237. The screw 234 is received in each of the mounting blocks 226 and 228. Specifically, the screw 234 is received in mounting block 226 such that the head 235 is received and rotatably movable in the countersink 232 and the shaft 236 is received and rotatably movable in the smooth bore 231. And the screw 234 is received in mounting block 228 such that the threaded portion 237 meshes with the threaded bore 233. The adjustment screws 234 shown in FIGS. 8 and 9 have a hex head 238, requiring a tool to turn the adjustment screws. As noted, the adjustment screws 234 also have a head 235, also referred to as an enlarged diameter portion, positioned at the bottom of mounting blocks 226A and 226B. This enlarged portion and the countersink 232 act to maintain the screw 234 in a constant position. Thus, by rotating each screw 234 at the hex head 238, the threaded portion 237 of screw 234 and the corresponding threaded bore 233 cause adjustment blocks 228A and 228B, and consequently upper cylinder 212, which is rotatably mounted therebetween, to move in relation to lower cylinder 210. In an alternative embodiment, the adjustment screws may be equipped with an adjustment handle which replaces the hex head and allows for adjustment of mounting blocks 226 and 228 by rotation without the need for a tool. Adjusting the adjustment screws 233 acts to increase or decrease the amount of clearance or spacing between lower cylinder 210 and upper cylinder 212, and therefore the amount of pressure applied by cylinders 210 and 212 to rear facer sheet 200 and the resulting size of apertures 208. Although not shown in this embodiment, the cylinders may be motorized so as to assist in movement of the rear facer 33 through the perforation device 206.

The joining of the various components can be seen with reference to FIG. 12. The assembled front facer 33 and rails 91 are continuously drawn into laminator 204. Prior to entry into laminator 204, a foam material 239 is provided through a nozzle 240 of a foam unit 241 onto the upwardly facing surface 242 of front facer 33. Foam material 239 may be any substance that expands and thereafter cures into a solid structure. Exemplary foam materials may include polyurethane/isocyanurate mixtures. In one or more embodiments the mix ratio may be about 50/50. In other embodiments, the foam material may be a pentane blown styrene foam. In one or more embodiments the foam density may be about 2.0 to about 2.8 pcf. In the present embodiment a single nozzle 240 is shown, though it should be appreciated that a plurality of nozzles may be employed. Just prior to entry into laminator 204, rear facer 200 having perforations 208 is brought into contact with rails 91 to create an enclosed volume. In other words, rails 91, front facer 33 and rear facer 200 form a closed exterior skin or perimeter, defining the volume therein. Thereafter, the assembled panel is drawn through laminator 204. Inside laminator 204, foam 239 continues to expand and substantially fill the volume defined by front facer 33, rear facer 200 and rails 91.

Laminator 204 may include a plurality of spaced rollers 244. One or more of the rollers 244 may be rotated in unison by a single or a plurality of roller motors (not shown). In the case of a single motor, the plurality of rollers may be interrelated by belts or chains so that rotation occurs in unison. Further, a belt may be provided below rollers 244 so that the assembled door panel is drawn continuously therebetween. Though the present embodiment discloses a roller and belt type laminator, other suitable types of laminators may be employed. For example, a roller chain conveyor using pressure platens may be used. Such laminators are disclosed in U.S. Pat. No. 5,836,499 which is hereby incorporated by reference. The rollers apply pressure to rear facer 200 as foam 239 cures, while riding along metal rails 91. The rollers may be adjustable to accommodate varying sizes of door panels.

During lamination any gasses and air that is trapped within the enclosed volume defined by rails 91, front facer 33 and rear facer 200 is forced out through apertures 208. Apertures 208 are sized such that the air and gas may escape through the conical apertures, but the foam 239 cannot, making apertures 208 self sealing. Partially cured foam 239 is selected to have too great a viscosity at the time the door panel passes through laminator 204 to pass through apertures 208, and becomes clogged within the conically shaped apertures 208. The correct sizing of apertures 208 may be achieved through trial and error adjustment of adjustment mechanism 230 of perforation device 206 and/or by decreasing the size of apertures 208 until no foam 239 escapes during lamination. Sizing may vary depending on the viscosity of the particular expanding foam 239 being used, as well as the number and spacing of apertures 208 provided by the perforating device 206.

In embodiments of the invention, the aperture size may range in diameter from about 0.4 to about 1.6 mm. In another embodiment an aperture having a diameter of 1.0 mm is created, with a density of about 130 apertures per square foot. In still another embodiment, an aperture having a diameter of about 1.5 mm is created, with a density of about 80 apertures per square foot. By allowing gasses and air to vent through rear facer 200, a more uniform flow of foam 239 is achieved, and consequently a more uniform resulting density within the door panel. The venting method described also helps to prevent the creation of hotspots, where higher density foam takes longer to cool. A more uniform foam density results in a stronger, more durable finished product.

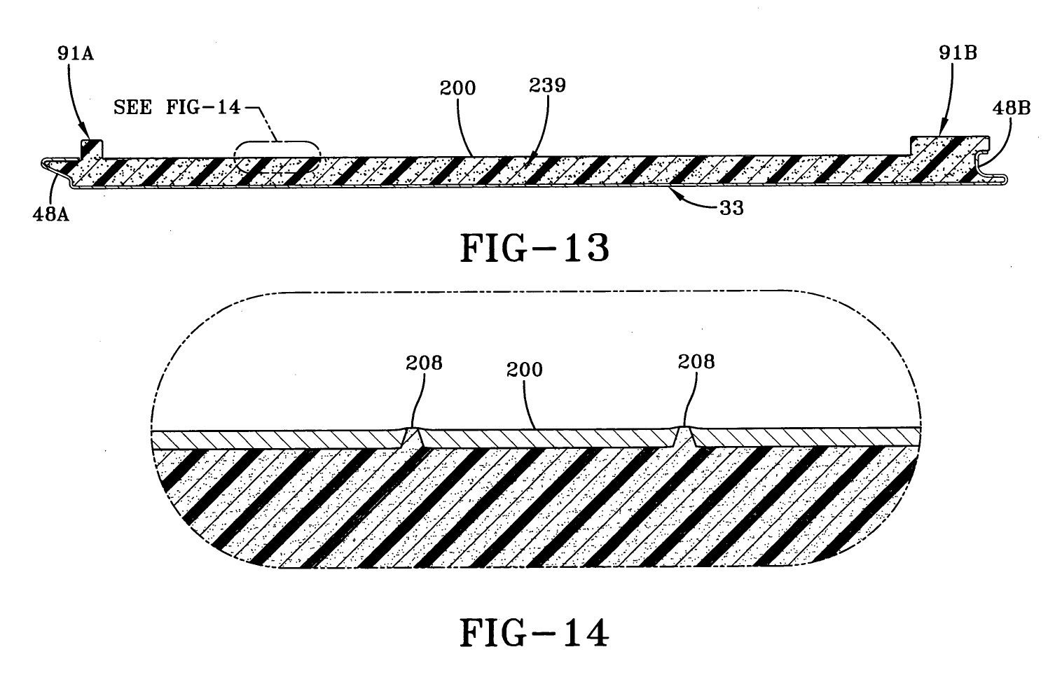

With reference now to FIGS. 13 and 14, the cross-sectional profile of the joined components can be seen. As is evident, left rail 91A is matingly fitted within left edge portion 48A. As discussed above, adhesive applied between left rail 91A and left edge portion 48A acts to secure the two together. Rear facer 200 rests on top of and in abutting relation to the opposite portion of rail 91A. An adhesive may be applied between left rail 91A and rear facer 200 by an adhesive applicator (not shown) positioned upstream of laminator 204. In this manner, rear facer 200 is coupled to left rail 91A Right rail 91B is matingly fitted with right edge portion 48B, and is secured thereto by adhesive. Rear facer 200 rests atop the left portion of right rail 91B, and may also be secured by adhesive.

As evidenced in FIGS. 13 and 14, foam 239 expands within the enclosed volume to fill substantially the entire area between front facer 33 and rear facer 200 and between rails 91A and 91B. Once cured, foam 239 provides both structural integrity and contributes to holding the various components together. To promote complete curing of foam 239, laminator rollers 244 may be positioned within an oven to elevate the temperature of the components. Thus, in this manner, as the assembled components move through laminator 204, foam 239 expands and hardens. Upon exiting the laminator 204, foam 239 is substantially cured, and the now rigid continuous length of the panel may be cut to the appropriate length. Individual cut panels may thereafter be equipped with additional hardware components.

In the above described manner, a panel having greater uniformity in density may be continuously formed. The rear facer may be perforated by a perforating device to create apertures in the rear facer, the perforating device including an upper and lower rotating cylinder, the lower cylinder having uniform piercing elements, and the upper cylinder having corresponding grooves. These apertures allow for venting of gasses and air, thereby promoting uniform flow of the expanding foam material and uniform density of the cured foam. Further, the above method provides for the continuous production of door panels having non-metal facers and a uniform foam density with superior adhesion to exterior door panel components.

Thus, it can be seen that the objects of the invention have been satisfied by the structure and its method for use presented above. While in accordance with the patent Statutes, only the best mode and preferred embodiment has been presented and described in detail, it is to be understood that the invention is not limited thereto and thereby. Accordingly, for an appreciation of the true scope and breadth of the invention, reference should be made to the following claims.

What is claimed is:

1. A method of venting a non-metallic sheet of material in a continuous lamination process of a product comprising:
continuously providing a sheet;
forming apertures in said sheet by continuously drawing said sheet through a perforating device
continuously applying said perforated sheet over a product which has a foaming material disposed thereon, said perforated sheet and said product forming an inner volume;
continuously drawing said product and said perforated sheet through a laminator, thereby securing said sheet to said product while said foaming material expands to fill said inner volume.

2. The method of claim 1 further comprising:
forming uniformly spaced apertures on said sheet with said perforation device.

3. The method of claim 1, further comprising:
passing said sheet between a lower cylinder and an upper cylinder in said perforating device, said lower cylinder having piercing elements, and said upper cylinder having grooves corresponding to said piercing elements, said cylinders having a gap therebetween, and each rotating about a central axis of rotation

4. The method of claim 3 wherein said lower cylinder and said upper cylinder are positioned so that the axis of said lower cylinder and the axis of said upper cylinder are parallel.

5. The method of claim 3 wherein said apertures are created by piercing elements having a conical shape.

6. The method of claim 5 further comprising:
adjusting the size of said apertures by adjusting said gap between said rotating cylinders.

7. The method of claim 6, further comprising:
rotatably mounting each said cylinder between a pair of mounting blocks; and
adjusting said gap by adjusting said pair of mounting blocks with respect to each other.

8. The method of claim 5, further comprising:
releasing gas and air trapped within said inner volume through said apertures.

9. The method of claim 1, further comprising:
forming said apertures by first piercing through an inner surface of said sheet to an outer surface of said sheet, wherein said inner surface is oriented to face said foaming area.

10. The method of claim 1 wherein said perforating device creates apertures having diameters between approximately 0.5 mm and 1.5 mm.

11. A method of forming a door panel comprising:
continuously providing a front facer having two opposing longitudinal edges, said edges each having a rail secured thereto;
continuously providing a rear facer wherein said rear facer is continuously drawn through a perforating device creating a perforated rear facer;
continuously applying an expanding foam material on said front facer;
continuously bringing said perforated rear facer into contact with said rails, thereby creating an enclosed inner cavity; and
drawing said front facer, said rails and said rear facer through a laminator including a plurality of rollers, wherein said rollers releasably position said rails and said rear facer as they are drawn through said laminator, and wherein entrapped air and gasses generated by said expanding foam material are released through said perforated rear facer.

12. The method of claim 11, further comprising:
forming apertures in said perforated rear facer by passing said rear facer between a lower cylinder and an upper cylinder in said perforating device, said lower cylinder having piercing elements, and said upper cylinder having grooves corresponding to said piercing elements, said cylinders having a gap therebetween, and each rotating about a central axis of rotation

13. The method of claim 12 wherein said lower cylinder and said upper cylinder are positioned so that the axis of said lower cylinder and the axis of said upper cylinder are parallel.

14. The method of claim 13, further comprising:
forming said apertures with piercing elements having a conical shape.

15. The method of claim 14 further comprising:
adjusting the size of said apertures by adjusting the gap between said rotating cylinders.

16. The method of claim 15, further comprising:
rotatably mounting each said cylinder between a pair of mounting blocks; and
adjusting said gap by adjusting said pair of mounting blocks with respect to each other.

17. The method of claim 11, further comprising:
forming said apertures by first piercing through an inner surface of said rear facer to an outer surface of said rear facer, wherein said inner surface is oriented to face enclosed inner cavity.

18. The method of claim 11 wherein said perforating device creates apertures having diameters between approximately 0.5 mm and 1.5 mm.
